(19) United States
(12) Patent Application Publication
(10) Pub. No.: US 2011/0268497 A1
(43) Pub. Date: Nov. 3, 2011

(54) COVER LATCHING MECHANISM

(75) Inventor: SHI-XU LIANG, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/862,856

(22) Filed: Aug. 25, 2010

(30) Foreign Application Priority Data
Apr. 29, 2010 (CN) 201010159388.1

(51) Int. Cl. F16B 1/00

(52) U.S. Cl. 403/327

(57) ABSTRACT

An exemplary cover latching mechanism includes a housing, a cover, a button, an ejecting element and a biasing element. The cover is latched to the housing. The button releasably latches the cover to the housing. The ejecting element releasably resists the button. The biasing element is compressed between the housing and the ejecting element to exert force on the ejecting element. When the button is pressed, the latching engagement between the button and the cover is released, and the resisting engagement between the button and the ejecting element is released, the ejecting element moves to and drives the cover away from the housing.

### BACKGROUND

1. Technical Field

The disclosure generally relates to cover latching mechanisms.

2. Description of Related Art

Batteries are widely used in electronic devices, such as personal digital assistants (PDAs), cellular phones, etc. Typically, a latching structure is used to latch a cover to the electronic device and thus to secure the battery (or batteries) between the cover and the electronic device. However, a typical latching structure may be hard to unlatch when the battery needs to be removed.

Therefore, there is a room for improvement within the art.

### BRIEF DESCRIPTION OF THE DRAWINGS

Many aspects of the exemplary cover latching structure can be better understood with reference to the following drawings. These drawings are not necessarily drawn to scale, the emphasis instead being placed upon clearly illustrating the principles of the exemplary cover latching structure. Moreover, in the drawings, like reference numerals designate corresponding parts throughout the several views. Wherever possible, the same reference numbers are used throughout the drawings to refer to the same or like elements of an embodiment.

FIG. 1 is an exploded, isometric view of part of an electronic device, showing a cover latching mechanism according to an exemplary embodiment.

FIG. 2 is similar to FIG. 1, but showing the cover latching mechanism in another aspect.

FIG. 3 is an isometric view of the electronic device of FIG. 1, showing the cover latching mechanism fully assembled except for a cover thereof.

FIG. 4 is similar to FIG. 3, but showing the cover latching mechanism fully assembled.

FIG. 5 is an enlarged, cross-sectional view of the electronic device shown in FIG. 4 taken along the line V-V thereof.

FIG. 6 is an enlarged, cross-sectional view of the electronic device shown in FIG. 4 taken along the line VI-VI thereof.

FIG. 7 is similar to the FIG. 5, but showing the cover released from a housing of the electronic device.

FIG. 8 is similar to the FIG. 6, but showing the cover released from the housing of the electronic device.

### DETAILED DESCRIPTION

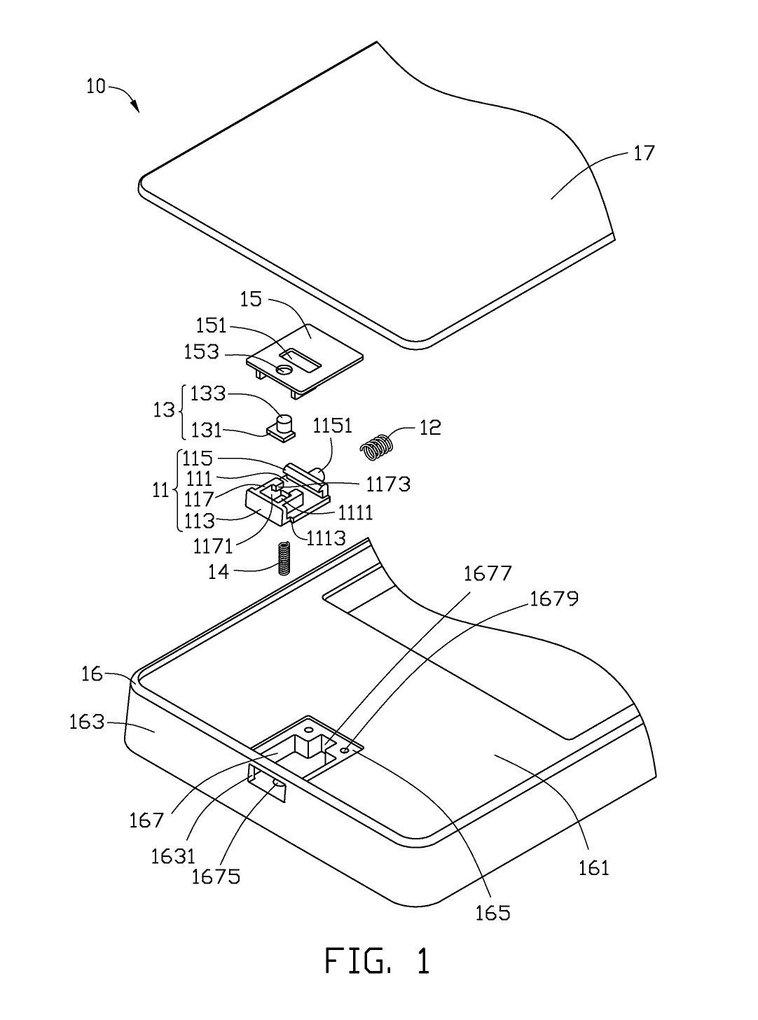

Referring to FIGS. 1 and 5-6, a cover latching mechanism 10 includes a button 11, an elastic element 12 (e.g., a compressed spring), an ejecting element 13 (e.g., a compressed spring), a biasing element 14, a board 15, a housing 16 and a cover 17. The button 11, the elastic element 12, the ejecting element 13, the biasing element 14 and the board 15 are mounted to the housing 16. The cover 17 releasably latches with the button 11 so that the cover 17 latches to the housing 16. The button 11 releasably latches with the ejecting element 13. When the button 11 is pressed, the cover 17 and the ejecting element 13 are both released from the button 11, and the biasing element 14 biases the ejecting element 13 to drive the cover 17 to move away from the housing 16.

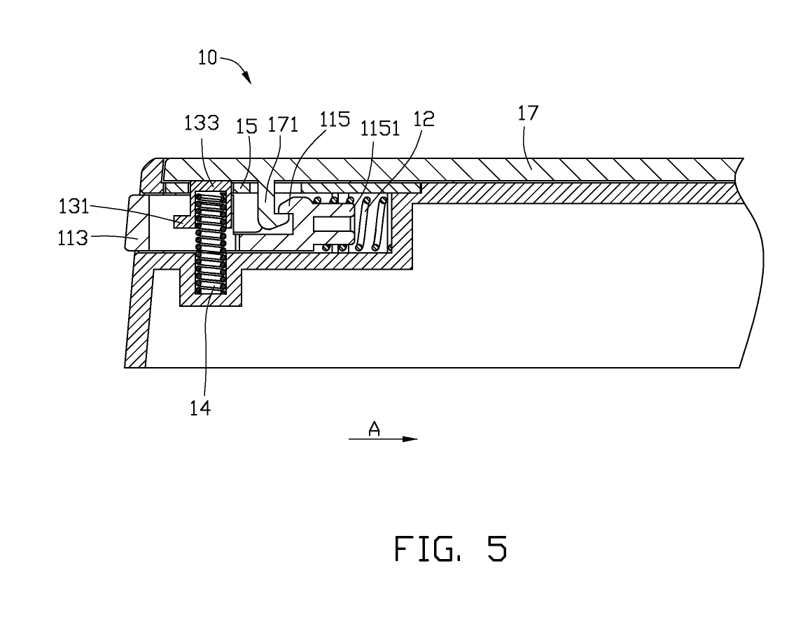

Referring to FIGS. 1 and 5, the button 11 includes a main body 111, a pressing portion 113, a latching portion 115 for latching the cover 17 to the housing 16, and two opposite blocks 117. The pressing portion 113 and the latching portion 115 are respectively located near opposite ends of the main body 111. The blocks 117 are located between the pressing portion 113 and the latching portion 115. The pressing portion 113 is for a user to control the button 11. The button 11 further includes a post 1151 protruding outwardly from the latching portion 115 for holding one end of the elastic element 12 on the button 11.

The main body 111 defines a mounting hole 1111 between the blocks 117, for the biasing element 14 to pass though the main body 111. The main body 111 further forms two shoulders 1113 respectively located at two sides of the pressing portion 113. The shoulders 1113 resist the housing 16 to prevent the button 11 separating from the housing 16. The button 11 further includes a mounting space 1171 defined between the blocks 117, for accommodating the ejecting element 13. Each block 117 has a protrusion 1173 protruding toward the other block 117. The protrusions 1173 are for preventing the ejecting element 13 from separating from the housing 16.

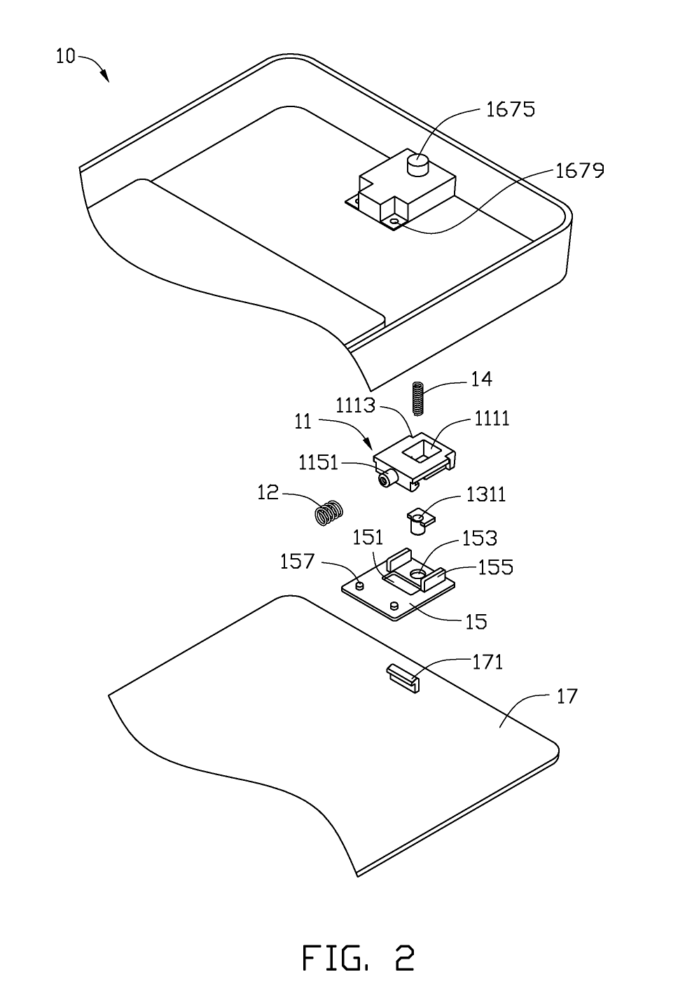

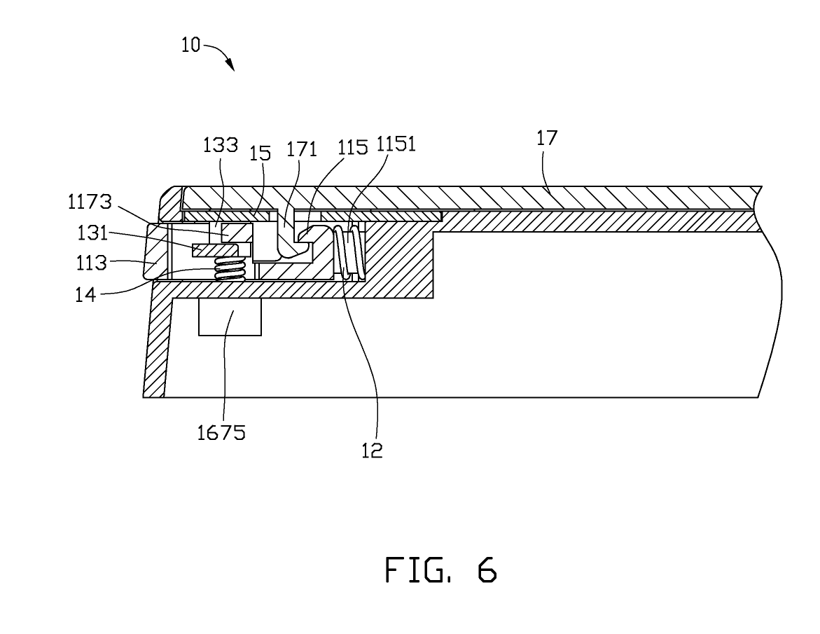

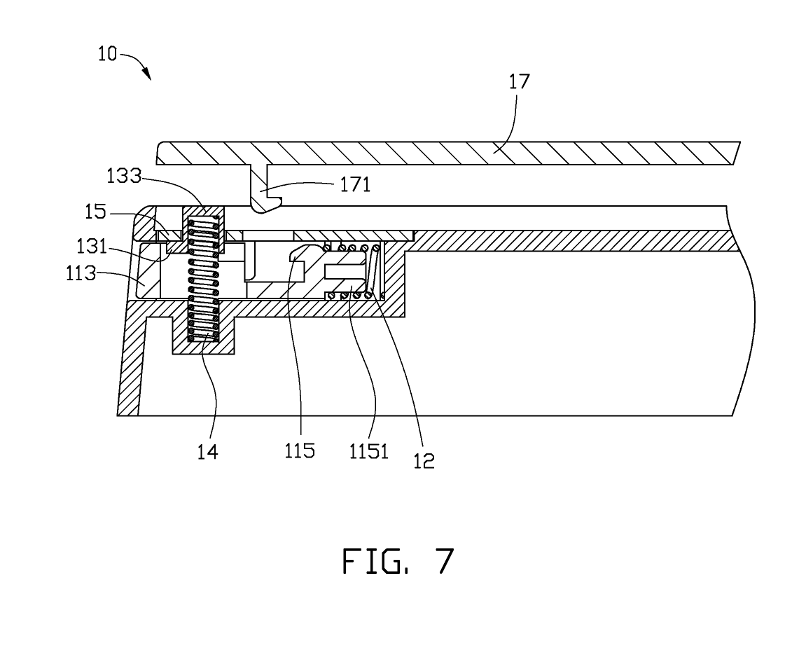

Referring to FIGS. 1 and 6, the ejecting element 13 includes a resisting plate 131, and a pole 133 protruding from the resisting plate 131. The resisting plate 131 resists the protrusions 1173 to prevent the ejecting element 13 separating from the housing 16. The resisting plate 131 further defines a recess 1311 (see FIG. 2) opposite to the pole 133, for accommodating one end of the biasing element 14. The pole 133 is for driving the board 15 away from the housing 16 (see FIG. 7)

Referring to FIGS. 1-2 and 5, the board 15 defines an opening 151 corresponding to the latching portion 115. The board 15 further defines a passage 153 adjacent to the opening 151. The passage 153 is for the pole 133 to pass through the board 15. The board 15 further includes two limiting plates 155 facing the button 11. Each limiting plate 155 resists one of the blocks 117, so that the button 11 can remain between the limiting plates 155. The board 15 further includes two retaining portions 157 protruding therefrom, for retaining the board 15 to the housing 16.

Referring to FIGS. 1-2 and 5, the housing 16 includes a base 161 and a sidewall 163 protruding from an edge of the base 161. The base 161 defines a mounting slot 165 near the sidewall 163, for mounting the board 15 to the housing 16. The base 161 further defines a receptacle 167 and two retaining holes 1679 in a bottom surface of the mounting slot 165. The receptacle 167 is for accommodating the button 11 in the housing 16. Each retaining hole 1679 holds one of the retaining portions 157, to retain the board 15 to the housing 16. The housing 16 further defines an aperture 1675 in a bottom surface of the receptacle 167 for accommodating another end of the biasing element 14, and a groove 1677 in the bottom surface of the mounting slot 165. The groove 1677 communicates with the receptacle 167, for accommodating another end of the elastic element 12. The sidewall 163 defines a button hole 1631, for the pressing portion 113 to be exposed out of the housing 16.

Referring to FIGS. 2 and 5, the cover 17 includes a hook 171 passing though the board 15 to latch with the latching portion 115.

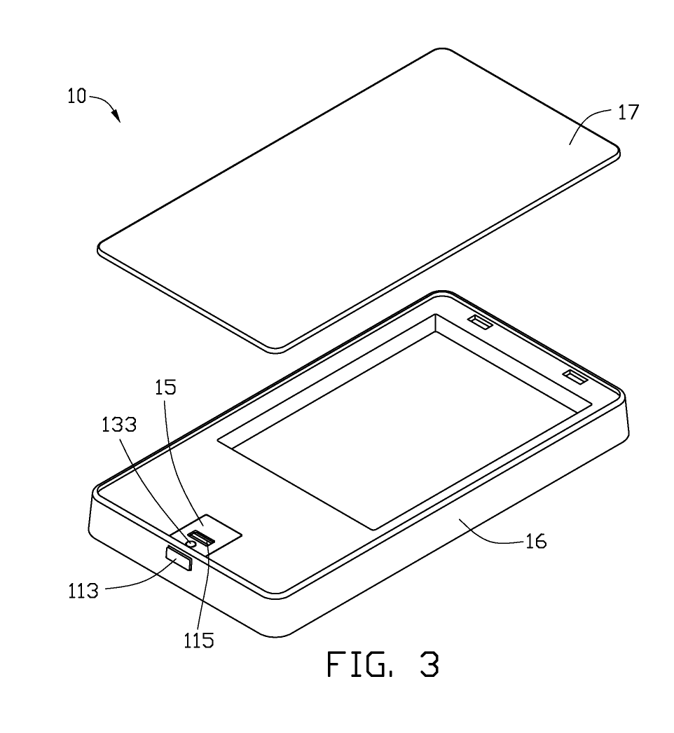

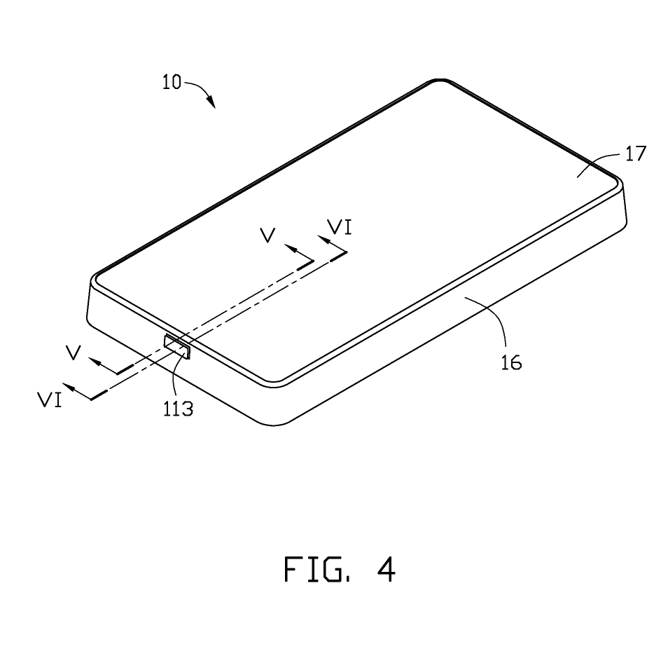

Referring to FIGS. 1 to 4, in assembly, said one end of the elastic element 12 wraps around the post 1151. The button 11 and the elastic element 12 are then both mounted in the receptacle 167, with the other end of the elastic element 12 located in the groove 1677 and the pressing portion 113 exposing out of the button hole 1631 under the elastic force of the elastic element 12. One end of the biasing element 14 is inserted in the recess 1311, and the pressing portion 113 is pushed toward the elastic element 12 until the mounting hole 1111 is aligned with the aperture 1675. At this time, the elastic element 12 is compressed to accumulate elastic potential energy. The ejecting element 13 and the biasing element 14 are then mounted in the mounting space 1171 until the other end of the biasing element 14 is received in the aperture 1675 and the resisting plate 131 is accommodated in the mounting space 1171. At this time, the biasing element 14 is compressed to accumulate potential energy. The pressing portion 113 is then released, and the protrusions 1173 move toward the button hole 1631 until the protrusions 1173 resist against the resisting plate 131 so that the ejecting element 13 is held in the button 11. The board 15 is mounted (e.g., wedged) in the mounting slot 165, with the retaining portions 157 retained in the retaining holes 1679, and each limiting plate 155 resisting one of the blocks 117 and the pole 133 passing through the passage 153. The cover 17 is mounted to the housing 16, with the hook 171 passing through the opening 151 to latch with the latching portion 115 so that the cover 17 is firmly mounted to the housing 16.

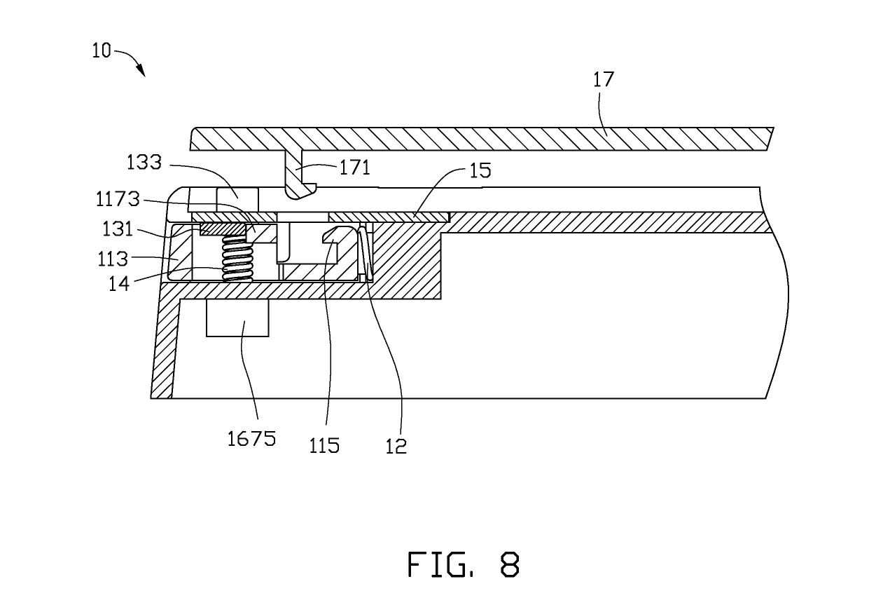

Referring to FIGS. 1 and 5-8, to release the cover 17 from the housing 16, the pressing portion 113 is pressed toward the elastic element 12 to compress the elastic element 12 until the hook 171 is released from the latching portion 115 and the resisting plate 131 is released from the protrusions 1173. Once the resisting plate 131 is released from the protrusions 1173, the pole 133 passes through the passage 153 under the elastic force of the biasing element 14 and then drives the cover 17 away from the housing 16. Then the resisting plate 131 resists the board 15 to prevent the ejecting element 13 from separating from the button 11, and the resisting plate 131 resists the protrusions 1173 in the pressing direction A (see FIG. 5) of the pressing portion 113 to prevent the pressing portion 113 from restoring to its original state.

Referring to FIGS. 1 and 5-8, to latch the cover 17 to the housing 16 again, the hook 171 is aligned with the opening 151. The cover 17 is pushed toward the housing 16 to press the ejecting element 13 until the ejecting element 13 passes through the protrusions 1173. Once the ejecting element 13 passes through the protrusions 1173, the button 11 moves toward the button hole 1631 until the shoulders 1113 resist the sidewall 163. At this moment, the protrusions 1173 latch with the resisting plate 131 to stop the ejecting element 13 moving toward the cover 17, and the latching portion 115 latches with the hook 171 to hold the cover 17 on the housing 16.

It is to be understood, however, that even through numerous characteristics and advantages of the exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cover latching mechanism comprising:
a housing;
a cover latched to the housing;
a button releasably latching the cover to the housing;
an ejecting element releasably resisting the button; and
a biasing element compressed between the housing and the ejecting element to exert force on the ejecting element;
wherein when the button is pressed, the latching engagement between the button and the cover is released, and the resisting engagement between the button and the ejecting element is released, and the ejecting element moves toward and drives the cover away from the housing.

2. The cover latching mechanism as claimed in claim 1, wherein the cover latching mechanism further includes an elastic element, one end of the elastic element resists the button, and another end of the elastic element resists the housing.

3. The cover latching mechanism as claimed in claim 1, wherein the button has two spaced blocks protruding therefrom, and each block has a protrusion protruding therefrom toward the other block; and the ejecting element includes a resisting plate releasably resisting the protrusions.

4. The cover latching mechanism as claimed in claim 3, wherein the ejecting element further includes a pole protruding from one side of the resisting plate, and the pole faces and is spaced apart from the cover when the ejecting element resists the protrusions.

5. The cover latching mechanism as claimed in claim 4, wherein the ejecting element defines a recess in the resisting plate opposite to the pole, and the recess accommodates one end of the biasing element therein.

6. The cover latching mechanism as claimed in claim 5, wherein the housing includes a base and a sidewall protruding from the base, the base defines a receptacle that accommodates the button therein, the sidewall defines a button hole that communicates with the receptacle, and the button is exposed out of the housing via the button hole.

7. The cover latching mechanism as claimed in claim 6, wherein the housing defines an aperture in a bottom surface of the receptacle, and another end of the biasing element opposite to the ejecting element is accommodated in the aperture.

8. The cover latching mechanism as claimed in claim 7, further comprising a board covering the receptacle, wherein the board defines a passage aligned with the pole.

9. The cover latching mechanism as claimed in claim 1, wherein the cover includes a hook protruding toward the button, and the button includes a latching portion releasably latching with the hook.

10. A cover latching mechanism comprising:
a housing;
a cover releasably latched to the housing;
a button slidably mounted in the housing and releasably latching with the cover; and
an ejecting element elastically resisted between the button and the housing, the ejecting element capable of pushing the cover away from the housing when the button is slid toward the inside of the housing to release the cover from the button.

11. The cover latching mechanism as claimed in claim 10, wherein the cover latching mechanism further includes a biasing element located between the housing and the ejecting element to exert force on the ejecting element.

12. The cover latching mechanism as claimed in claim 10, further comprising an elastic element, wherein one end of the elastic element resists the button, and another end of the elastic element resists the housing.

13. The cover latching mechanism as claimed in claim 11, wherein the button has two spaced blocks protruding therefrom, and each block protrudes a protrusion toward the other block; the ejecting element includes a resisting plate releasably resisting the protrusions.

14. The cover latching mechanism as claimed in claim 13, wherein the ejecting element further has a pole protruding from one side of the resisting plate, the pole faces and is spaced apart from the cover when the ejecting element resists the protrusions.

15. The cover latching mechanism as claimed in claim 14, wherein the ejecting element further defines a recess in the resisting plate opposite to the pole, the recess accommodates one end of the biasing element therein.

16. The cover latching mechanism as claimed in claim 15, wherein the housing includes a base and a sidewall protruding from the base, the base defines a receptacle that accommodates the button therein, the sidewall defines a button hole communicates with the receptacle, the button is exposed out of the housing by the button hole.

17. The cover latching mechanism as claimed in claim 16, wherein the housing further defines an aperture in a bottom surface of the receptacle, another end of the biasing element opposite to the ejecting element is accommodated in the aperture.

18. The cover latching mechanism as claimed in claim 17, wherein the cover latching mechanism further includes a board covering the receptacle, the board defines a passage aligned with the pole.

19. The cover latching mechanism as claimed in claim 10, wherein the cover includes a hook protruding toward the button, the button includes a latching portion releasably latching with the hook.

20. A cover latching mechanism used to releasably latch a cover to a housing, the cover latching mechanism comprising:
a button slidably mounted in the housing and releasably latching with the cover;
an ejecting element resisted between the button and the housing; and
a biasing element resisted between the ejecting element and the housing;
wherein when the button is pressed along a first direction to release the cover from the button, the ejecting element drives the cover away from the housing along a second direction substantially perpendicular to the first direction under force of the biasing element.
